(19) United States
(12) Patent Application Publication
(10) Pub. No.: US 2024/0287416 A1
(43) Pub. Date: Aug. 29, 2024

(54) BENEFIT AGENT DELIVERY PARTICLES

(71) Applicant: Conopco Inc., d/b/a UNILEVER, Englewood Cliffs, NJ (US)

(72) Inventor: Paul Ferguson, Wageningen (NL)

(73) Assignee: Conopco Inc., d/b/a UNILEVER, Englewood Cliffs, NJ (US)

(21) Appl. No.: 18/572,194

(22) PCT Filed: Jun. 28, 2022
(86) PCT No.: PCT/EP2022/067801

§ 371 Date: Dec. 20, 2023

(30) Foreign Application Priority Data
Jun. 30, 2021 (EP) 21182918.9

(51) Int. Cl. C11D 3/37; B01J 13/12; B01J 13/22; C11D 3/22; C11D 17/00

(52) U.S. Cl. CPC C11D 3/3715; B01J 13/125; B01J 13/22; C11D 3/222; C11D 17/0039

(57) ABSTRACT

A Provided herein is a benefit agent delivery particle having a core-shell structure in which a shell of polymeric material entraps a core containing benefit agent, and the shell includes a recycled polymer.

The present invention relates to delivery particles for benefit agents for use in the treatment of fabrics and compositions (such as laundry treatment compositions) comprising such particles.

Benefit agents offer fabric treatment e.g. care benefits but are expensive and can have poor efficacy when employed even at high levels in aqueous treatment processes, especially those involving surfactants particularly linear alkylbenzene sulfonates. Effective encapsulation techniques typically comprise polymers such as melamine formaldehyde polymers. However, consumer find these are less desirable environmentally.

Despite the prior art, there remains a need for environmentally friendly delivery particles which can be used to deliver fabric benefits such as care benefits in laundry formulations.

The invention provides in a first aspect a benefit agent delivery particle comprising a core-shell structure in which a shell of polymeric material entraps a core containing benefit agent, wherein said shell comprises a waste polymer.

In a second aspect the invention provides a laundry treatment composition comprising a benefit agent delivery particle as defined above.

In a further aspect the invention provides a method of making a benefit agent delivery particle comprising a core-shell structure in which a shell entraps a core containing benefit agent, the method comprising the step of
a. providing a waste polymer feedstock
b. forming the shell from the waste polymer feedstock so as to entrap the benefit agent.

Preferably the method includes solvation of the waste polymer feedstock with a solvent.

Preferably the method utilizes waste polymer comprising post-consumer recycled (PCR) polymer/s or post-industrial recycled (PIR) polymer/s and mixtures thereof.

In a yet further aspect, the invention provides a method of making a laundry treatment composition comprising adding a benefit agent delivery particle to said composition.

The arrangement of the invention has the advantage that waste polymeric feedstocks, including consumer waste or industrial waste can be used to manufacture microcapsules thereby recycling used polymeric material.

### Benefit Agent Delivery Particle

The core of the particle is suitably formed in an inner region, inner being relative to the shell. Particles may be prepared using methods known to those skilled in the art such as coacervation, interfacial polymerization, and polycondensation.

The process of coacervation typically involves encapsulation of a generally water-insoluble core material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration.

Interfacial polymerisation typically proceeds with the formation of a fine dispersion of oil droplets (the oil droplets containing the core material) in an aqueous continuous phase. The dispersed droplets form the core of the future core-shell particle and the dimensions of the dispersed droplets directly determine the size of the subsequent core-shell particles. Shell-forming materials (monomers or oligomers) are contained in both the dispersed phase (oil droplets) and the aqueous continuous phase and they react together at the phase interface to build a polymeric wall around the oil droplets thereby to encapsulate the droplets and form core-shell particles. An example of a core-shell particle produced by this method is a polyurea core-shell particle with a shell formed by reaction of diisocyanates or polyisocyanates with diamines or polyamines.

Polycondensation involves forming a dispersion or emulsion of the core material in an aqueous solution of precondensate of polymeric materials under appropriate conditions of agitation to produce dispersed core material of a desired particle size, and adjusting the reaction conditions to cause condensation of the precondensate by acid catalysis, resulting in the condensate separating from solution and surrounding the dispersed core material to produce a coherent film and the desired core-shell particles.

### Waste Polymer

The waste polymer may be sourced from any suitable waste polymer feedstock preferably waste polymeric packaging such as waste bottles, bags, including drinking cups and food ware

Preferably the waste polymer comprises post-consumer recycled (PCR) polymer/s or post-industrial recycled (PIR) polymer/s and mixtures thereof.

Preferably the waste polymer comprises waste polyester.

### Waste Polyester.

The waste polyester may comprise a synthetic or natural polyester.

Preferably the waste polyester is hydrophobic.

Preferably the waste polyester comprises an aliphatic polyester.

Preferably the waste polyester comprises a biodegradable polyester.

Preferably the waste polyester is compostable. In this regard, most preferably the shell comprises a linear aliphatic polyester.

Firmicutes and proteobacteria can degrade PCL.[9] Penicillium sp. strain 26-1 can degrade high density PCL; though not as quickly as thermotolerant Aspergillus sp. strain ST-01. Species of Clostridium can degrade PCL under anaerobic conditions.

Virgin polyesters may be produced by biosynthesis using fermentation, using random polymerization, ring opening polymerization, and the block copolymerization techniques.

The recycled polyester may comprise any of polylactic acid (PLA), polyglycolic acid (PGA), poly-ε-caprolactone (PCL), polyhydroxybutyrate (PHB), and poly(3-hydroxy valerate), poly(ethylene succinate) (PESu), poly(propylene succinate) (PPSu) and poly(butylene succinate) (PBSu), polyhydroxyhexanoate, polyhydroxyoctanoate, furan-based polyesters, e.g. polyesters based on furan dicarboxylic acid (e.g., polyethylene 2,5-furandicarboxylate (PEF), or any combination or thereof.

Co-polymers comprising any of the above polyesters or blends of co-polymers are included in the invention.

The shell may comprise at least 10% waste polymer, preferably at least 20% wt, more preferably at least 30% wt, even more preferably at least 50% wt, most preferably at least 75% wt (% wt based on total weight of the shell and excluding any deposition aids) In some embodiments, the shell is 90-100 wt % waste polymer. Highly preferred are shells wherein the shell has 100% wt recycled polymer.

Preferably the waste polymer e.g waste consumer packaging for example drinking cups, container,

The waste polymer may comprise waste plastic. The plastic is preferably a thermoplastic material (not crosslinked, i.e. thermoset) and soluble in non-water miscible organic solvents to allow for encapsulation techniques. Examples include, but are not limited to, high density polyethylene (HDPE), low density polyethylene (LDPE), polystyrene (PS), Polypropylene (PP), polyethylene terephthalate (PET), Polyvinyl chloride, or PVC.

### Microcapsule Shell Shape and Size

The shell is preferably of a generally spherical shape; and will typically comprise at most 20% by weight based on the total weight of the core-shell particle.

The particles preferably have an average particle size between 100 nanometers and 50 microns. Particles larger than this are entering the visible range.

The particles may have an average size of from 0.6 to 50 microns.

One benefit of small particles is that they can deposit via diffusion onto fibres of fabric. Accordingly, preferably the core shell particles have an average size of from 0.6-1 micron.

One benefit of larger particles, is that they deposit by filtration: the impact the fibres and become lodged thereon. Thus, advantageously the particles are 3 to 30 microns, preferably from 5 to 25 microns.

The particle size distribution can be narrow, broad or multimodal. If necessary, the core-shell particles as initially produced may be filtered or screened to produce a product of greater size uniformity.

### Charge

Core-shell particles suitable for use in the invention may be positively or negatively charged. However, it is preferred that the core-shell particles are negatively charged and have a zeta potential of from −0.1 meV to −100 meV, more preferably from −10 meV to −80 meV, and most preferably from −20 meV to −75 meV. The zeta potential is suitably measured by a dynamic light scattering (DLS) method using a Zetasizer Nano™ ZS90 (Malvern Instruments Ltd, UK) at 25° C. A dispersion of the core-shell particles in deionised water with a solids content of around 500 ppm and a pH adjusted to about 7 is used for the measurement.

### Deposition Aids

The particles of the invention are preferably provided with a deposition aid at the outer surface of the particle. Deposition aids can modify the properties of the exterior of the particle to make the particle more substantive to a specific substrate. Advantageously, the deposition aid is substantive to fabric substrates as defined herein, but preferably including cellulosics (including cotton) and/or polyesters (including those employed in the manufacture of polyester fabrics).

The deposition aid may suitably be provided at the outer surface of the particle by means of covalent bonding, entanglement or strong adsorption. The deposition aid is preferably attached to the outside of the shell, and preferably by means of covalent bonding.

The deposition may be attached directly to shell.

The deposition aid may be present at 0.1-10 wt %, preferably 1-5 wt %, more preferably 1.5 to 3 wt %, most preferably 2 wt % based on total weight of the encapsulate.

The deposition aid may be attached to the encapsulate as part of the encapsulation process, so peri-encapsulation (generally in the latter stages of a time period in which encapsulation takes place) or post encapsulation (after completion of the encapsulation process). In the latter case, this may involve use of a pre-polymer (e.g. trimethylolmelamine for aminoplast shells e.g. melamine formaldehyde shells) which can be added with the deposition aid.

While it is preferred that the deposition aid is attached directly to the outside of the shell, it may also be attached via a linking species. The deposition aid is preferably covalently bonded to the outer surface of the microcapsule shell.

The deposition aid may comprise a nonionic polysaccharide polymer. The nonionic polysaccharide polymer may comprise branched and unbranched materials having a β-1,4-backbone and of branched and unbranched materials having a β-1,3-linked backbone. Preferably the nonionic polysaccharide polymer comprises branched and unbranched materials having a β-1,4-backbone.

Deposition aids for use in the invention may suitably be selected from polysaccharides having an affinity for cellulose. Such polysaccharides may be naturally occurring or synthetic and may have an intrinsic affinity for cellulose or may have been derivatised or otherwise modified to have an affinity for cellulose. Suitable polysaccharides have a 1-4 linked β glycan (generalised sugar) backbone structure with at least 4, and preferably at least 10 backbone residues which are β1-4 linked, such as a glucan backbone (consisting of β1-4 linked glucose residues), a mannan backbone (consisting of β1-4 linked mannose residues) or a xylan backbone (consisting of β1-4 linked xylose residues). Preferred β1-4 linked polysaccharides include xyloglucans, glucomannans, mannans, galactomannans, β(1-3),(1-4) glucan and the xylan family incorporating glucurono-, arabino- and glucuronoarabinoxylans.

More preferably the deposition aids comprises xyloglucans or galactomannans.

Preferred depositions aids may be selected from xyloglucans of plant origin, such as pea xyloglucan and tamarind seed xyloglucan (TXG) (which has a β1-4 linked glucan backbone with side chains of α-D xylopyranose and β-D-galactopyranosyl-(1-2)-α-D-xylo-pyranose, both 1-6 linked to the backbone); and galactomannans of plant origin such as locust bean gum (LBG) (which has a mannan backbone of β1-4 linked mannose residues, with single unit galactose side chains linked α1-6 to the backbone).

Most preferred are xyloglucans.

Also suitable are polysaccharides which may gain an affinity for cellulose upon hydrolysis, such as cellulose mono-acetate; or modified polysaccharides with an affinity for cellulose such as hydroxypropyl cellulose (HPC), hydroxypropyl methylcellulose, hydroxyethyl methylcellulose, hydroxypropyl guar, hydroxyethyl ethylcellulose and methylcellulose.

Deposition aids for use in the invention may also be selected from phthalate containing polymers having an affinity for polyester. Such phthalate containing polymers may have one or more nonionic hydrophilic segments comprising oxyalkylene groups (such as oxyethylene, polyoxyethylene, oxypropylene or polyoxypropylene groups), and one or more hydrophobic segments comprising terephthalate groups. Typically, the oxyalkylene groups will have a degree of polymerization of from 1 to about 400, preferably from 100 to about 350, more preferably from 200 to about 300. A suitable example of a phthalate containing polymer of this type is a copolymer having random blocks of ethylene terephthalate and polyethylene oxide terephthalate.

Mixtures of any of the above described materials may also be suitable.

The microcapsules shell may be coated with polymer to enhance the ability of the microcapsule to adhere to fabric, as described in U.S. Pat. Nos. 7,125,835; 7,196,049; and 7,119,057.

Deposition aids for use in the invention will generally have a weight average molecular weight (M_{w}) in the range of from about 5 kDa to about 500 kDa, preferably from about 10 kDa to about 500 kDa and more preferably from about 20 kDa to about 300 kDa.

### Method of Manufacture

The method of the invention preferably includes solvating the waste polymer feedstock with a solvent. Organic solvents are preferred, e.g. halogenated hydrocarbons, such as dichloromethane (CH2Cl2).

The method of making a benefit agent delivery particle according to the invention may include the pre-step of emulsifying the benefit agent with an emulsifier. This step is preferably carried out prior to adding the benefit agent to shell material.

Emulsifiers include any colloidal stabilisers or surfactants. Preferably the emulsifier a low-foaming emulsifier. Preferably the emulsifier is a polymeric colloidal stabliser. A preferred polymer is PVOH. Other examples include sorbitan esters, polysorbates and blends of these. Synthetic water soluble polymers which are suitable include:
(1) polyvinyl pyrrolidone;
(2) water soluble celluloses;
(3) polyvinyl alcohol;
(4) ethylene maleic anhydride copolymer;
(5) methyl vinyl ether maleic anhydride copolymer;
(6) polyethylene oxides;
(7) water soluble polyamide or polyester;
(8) copolymers or homopolymers of acrylic acid such as polyacrylic acid, polystyrene acrylic acid copolymers or mixtures of two or more.

The method preferably includes the step of attaching to said shell a deposition aid such as any of the deposition aids described herein. The step of attaching the deposition aid to said shell using a linking agent. The linking agent may be homobifunctional (same reactive groups) or heterobifunctional (different reactive groups). The linking agent may be a water soluble carbodiimide. A preferred water soluble carbodiimide is ethyl-3-(3-dimethylaminopropyl)carbodiimide (EDC, EDAC).

### Benefit Agents

Preferred benefit agents in the context of fabric treatment include fragrance formulations, clays, enzymes, antifoams, fluorescers, bleaching agents and precursors thereof (including photo-bleach), dyes and/or pigments, conditioning agents (for example cationic surfactants including water-insoluble quaternary ammonium materials, fatty alcohols and/or silicones), lubricants (e.g. oils), colour and photo-protective agents (including sunscreens), antioxidants, ceramides, reducing agents, sequestrants, colour care additives (including dye fixing agents), unsaturated oil, emollients, moisturizers, insect repellents and/or pheromones, drape modifiers (e.g. polymer latex particles such as PVAc) and antimicrobial or microbe control agents.

Mixtures of any of the above described materials may also be suitable. The most preferred benefit agents in the context of this invention are non-volatile benefit agents. In this specification a “non-volatile benefit agent” means a benefit agent that does not volatilise too much. A perfume is not non-volatile. When applied to a surface and left at 25° C. a non-volatile material will lose less than 50% of its mass over a time of 7 days. A non-volatile functional material typically has a boiling point greater than 250° C. Examples of non-volatile benefit agents include silicone oils or ester oils.

### Oils

A particular preferred class of benefit agent is an oil.

### Natural Oils

Natural oils preferably comprise plant oils, and exclude mineral oils derived from petroleum.

### Plant Oils

Plant oils include vegetable, nut and seed oils. Plant oils include microbial oils, which are oils that produced by microbes or other organisms, including algal oils and including genetically modified or engineered microbes that produce oils.

Plant oils preferably include triglycerides, free fatty acids, or a combination of both.

### Seed Oils

Seed oils include almond, argan, babassu, borage, camelina, Canola®, castor, chia, cherry, coconut, corn, cotton, coffee, Cuphea viscosissima, flax (linseed), grape, hemp, hepar, jatropha, jojoba, Lesquerella fendleri oil, Moringa Oleifera oil, macadamia, mango, mustard, neem, oil palm, perilla, rapeseed, safflower, sesame, shea, stillingia, soybean, sunflower, tonka bean, tung.

### Vegetable Oils

Vegetable oils include olive oil, palm, rice bran oils.

The natural oil may comprise a triglyceride or mixtures of triglycerides with varying degrees of alkyl chain length and unsaturation. The or each triglyceride comprises one or two or more, preferably three fatty acids, bonded by a glycerol bridge.

### Ester Oils

The oil may comprise an ester oil. Ester oils are the esterified fatty acids of any of the above oils. The glycerides of the above oils are first hydrolysed to release fatty acids from the glycerol moiety. The fatty acids and glycerol are then separated. The fatty acids may be purified to produce more concentrated alkyl chain lengths. The separated fatty acids are then reacted with alcohols (mono-, di-, tri-, tetra, etc.) to form an ester oil.

### Silicones

Non-volatile benefit agents which may be used with the invention include silicone.

The silicone may generally have a volume average primary particle size in the range from about 1 nm to 100 microns, including microemulsions (<150 nm), standard emulsions (about 200 nm to about 500 nm) and macroemulsions (>1 micron). Preferably the volume average primary particle size is in the range from about 10 nm to about 10 microns, such as from 1 to 5 microns. The volume average primary particle size can be measured using a Coulter Multisizer™

Suitable silicones for use in the invention include polydimethylsiloxanes, or modified polydimethylsiloxanes such as carboxyl functionalised polydimethylsiloxanes. Carboxyl functionalised polydimethylsiloxanes contain at least one terminal and/or pendant carboxylic acid group chosen from carboxylic acid groups in free acid form (i.e. —COOH), and/or carboxylic acid groups in salt form (i.e. —COOM in which M may be chosen from inorganic cations such as sodium, potassium and ammonium; and organic cations such as monoethanolammonium, diethanolammonium and triethanolammonium).

Preferred silicones for use in the invention have a molecular weight ranging from about 1,000 to about 100,000 g/mol, more preferably from about 2,000 to about 50,000 g/mol and most preferably from 5,000 to 50,000 g/mol.

In a laundry composition according to the invention, the total amount of benefit agent as defined above suitably ranges from 0.1 to 5%, and preferably ranges from 0.1 to 4%, more preferably from 0.1 to 2.5% (by weight based on the total weight of the composition).

Preferably the silicone has a viscosity of 10-50,000 cPs, preferably 1000-30,000 cPs, more preferably 3000-15,000 cPs, most preferably 5000-13,000 cPs. Advantageously the silicone has a viscosity of 9000-11000 cPS, most desirably 10,000 cPs.

### Definitions

As used herein, the following terms are defined:

The articles “a” and “an” when used in a claim, are understood to mean one or more of what is claimed or described; and “include”, “includes” and “including” are meant to be non-limiting.

“detergent composition” in the context of this invention denotes formulated detergent (cleaning) compositions, generally containing detersive surfactants, and intended for and capable of treating substrates as defined herein

“detersive surfactant” in the context of this invention denotes a surfactant which provides a detersive (i.e. cleaning) effect to a substrate such as fabric treated as part of a domestic treatment e.g. laundering process.

“encapsulate” encompasses microcapsules, including “benefit agent containing microcapsules@ and the terms “core-shell particles”, “encapsulate” or “benefit agent containing delivery particle” and “microcapsule” are synonymous and may be used interchangeably and may further comprise deposition aids as herein described.

“linking agent” is used interchangeably with “coupling agent” and “grafting agent”, “washing operation” as used herein generally denotes a method of laundering fabric using a laundry treatment composition according to the invention.

“waste” materials encompass post-consumer recycled (PCR) materials, post-industrial recycled (PIR) polymeric materials and mixtures thereof. The recycled polymer may be sourced from any suitable waste polymer feedstock for example, waste consumer packaging such as bottles, bags, including drinking cups and foodware or waste industrial feedstocks Such materials are collected from waste streams after consumer use or manufacturing process (the first ‘cycle’ of use) and may be PCR or PIR as defined below.

“Post-consumer recycled” (PCR) refers to material (e.g., a polymer or polymers) that has reached the intended end user or consumer, is no longer being used for its intended purpose, and which has been collected or reclaimed after it is discarded by the end user or consumer. Such material is the waste Thus, for example, it is understood that the term refers to material that would have otherwise been disposed of as waste but has instead been collected and recovered (reclaimed) as a material input, in lieu of new virgin material, for a recycling or manufacturing process. The term is inclusive of such collected or reclaimed materials which have been further treated or processed to facilitate re-use of the material. Thus, for example, the term is inclusive of material that has been reprocessed from collected or reclaimed material by means of a manufacturing process and made into a product or into a component for incorporation into a product. The term recycled includes polymers that have been used and thereafter entered an established recycling stream.

“post-industrial recycled” (PIR) refers to material (e.g., a polymer or polymers) that has never reached the end user and has been collected or reclaimed from a waste stream produced in a manufacturing process. The term “post-industrial recycled” does not include materials that are generated in a manufacturing process and then are reused as a substitute for a raw material in the same manufacturing process, such as regrind polymer that is collected from the waste stream of a manufacturing process (e.g., a thermoforming process), ground to reduce its size, and then reused as a substituted for virgin polymer in the same manufacturing process (e.g., the same thermoforming process). The term is inclusive of such collected or reclaimed materials which have been further treated or processed to facilitate re-use of the material in another manufacturing process.

“Polymer” as used in the present application denotes a material having a weight average molecular weight (Mw) of at least 5,000.

“regrind” material is thermoplastic waste material, such as sprues, runners, excess parison material, and reject parts from injection and blow molding and extrusion operations, which has been reclaimed by shredding or granulating.

“substantially free of” or “substantially free from” refers to either the complete absence of an ingredient or a minimal amount thereof merely as impurity or unintended byproduct of another ingredient. A composition that is “substantially free” of/from a component means that the composition comprises less than 0.5%, 0.25%, 0.1%, 0.05%, or 0.01%, or even 0%, by weight of the composition, of the component.

“Size” refers to diameter unless otherwise stated. For samples with particle diameter no greater than 1 micron, diameter means the z-average particle size measured, for example, using dynamic light scattering (as set out in international standard ISO 13321) with an instrument such as a Zetasizer Nano™ ZS90 (Malvern Instruments Ltd, UK). For samples with particle diameter greater than 1 micron, diameter means the apparent volume median diameter (D50), measurable for example, by laser diffraction (as set out in international standard ISO 13320) with an instrument such as a Mastersizer™ 2000 (Malvern Instruments Ltd, UK).

“Substrate” preferably is any suitable substrate and includes but is not limited to fabric substrates. Fabric substrates includes clothing, linens and other household textiles etc. In the context of fabrics, wherein the term “linen” is used to describe certain types of laundry items including bed sheets, pillow cases, towels, tablecloths, table napkins and uniforms and the term “textiles” can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

“Treatment” in the context of treating substrates may include cleaning, washing, conditioning, lubricating, care, softening, easy-ironing, anti-wrinkle, fragrancing, malodour reduction, de-pilling, rejuvenation including colour rejuvenation, soaking, pretreatment of substrates, bleaching, colour treatments, soil removal, stain removal and any combination thereof.

“Virgin polymer” as used herein denotes a polymer that has not been used by a consumer/end user and then recycled.

Unless otherwise noted, all component or composition levels are in reference to the active portion of that component or composition, and are exclusive of impurities, for example, residual solvents or by-products, which may be present in commercially available sources of such components or compositions.

Dimensions and values disclosed herein are not to be understood as being strictly limited to the exact numerical values recited. Instead, unless otherwise specified, each such dimension is intended to mean both the recited value and a functionally equivalent range surrounding that value. For example, a value disclosed as “50 microns’ is intended to mean “about 50 microns.”

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Product Form

The benefit agent delivery particles of the invention are suitable for incorporation into laundry treatment compositions of all physical forms. Laundry treatment compositions according to the invention may be in any suitable form.

Preferably the benefit agent delivery particles are present in the range from 0.01 to 10%, preferably from 0.1 to 5%, more preferably from 0.3 to 3% (by weight based on the total weight of the composition).

The term liquid” in the context of this invention denotes that a continuous phase or predominant part of the composition is liquid and that the composition is flowable at 15° C. and above. Accordingly, the term “liquid” may encompass emulsions, suspensions, and compositions having flowable yet stiffer consistency, known as gels or pastes. The viscosity of the composition may suitably range from about 200 to about 10,000 mPa·s at 25° C. at a shear rate of 21 sec-1. This shear rate is the shear rate that is usually exerted on the liquid when poured from a bottle. Pourable liquid compositions generally have a viscosity of from 200 to 2,500 mPa·s, preferably from 200 to 1500 mPa·s. Liquid compositions which are pourable gels generally have a viscosity of from 1,500 mPa·s to 6,000 mPa·s, preferably from 1,500 mPa·s to 2,000 mPa·s.

The laundry treatment composition according to the invention may comprise a detersive surfactant.

The laundry treatment may comprise a wash cycle of automatic washing machines or by hand.

A laundry detergent composition according to the invention generally comprises at least 3%, such as from 5 to 90% (by weight based on the total weight of the composition) of one or more detersive surfactants.

The total amount of surfactant may be 60% (by weight based on the total weight of the composition) in a composition for washing fabrics by hand. In compositions for machine washing of fabrics, an amount of from 5 to 40%, such as 15 to 35% (by weight based on the total weight of the composition) is generally appropriate.

Preferred detersive surfactants may be selected from non-soap anionic surfactants, nonionic surfactants and mixtures thereof.

Non-soap anionic surfactants are principally used to facilitate particulate soil removal. Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

A highly preferred class of non-soap anionic surfactant for use in the invention includes alkylbenzene sulfonates, particularly linear alkylbenzene sulfonates (LAS) with an alkyl chain length of from 10 to 18 carbon atoms. LAS is particularly effective as a surfactant. LAS and certain benefit agents, in particular certain oils such as ester oils are incompatible in liquid/gel formulations however, with the encapsulation arrangement of the invention, a LAS-rich laundry liquids (where LAS is incorporated above 5 wt %, preferably above 7 wt % of the total composition) with fabric care benefits can be formulated.

Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Also suitable are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule.

Some alkyl sulfate surfactant (PAS) may be used, such as non-ethoxylated primary and secondary alkyl sulphates with an alkyl chain length of from 10 to 18.

Mixtures of any of the above described materials may also be used. A preferred mixture of non-soap anionic surfactants for use in the invention comprises linear alkylbenzene sulfonate (preferably C11 to C15 linear alkyl benzene sulfonate) and sodium lauryl ether sulfate (preferably C10 to C18 alkyl sulfate ethoxylated with an average of 1 to 3 EO).

In a laundry detergent according to the invention, the total level of non-soap anionic surfactant may suitably range from 5 to 30% (by weight based on the total weight of the composition).

Nonionic surfactants may provide enhanced performance for removing very hydrophobic oily soil and for cleaning hydrophobic polyester and polyester/cotton blend fabrics. Nonionic surfactants for use in the invention are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

Mixtures of any of the above described materials may also be used.

In a laundry detergent according to the invention, the total level of nonionic surfactant may suitably range from 0 to 25% (by weight based on the total weight of the composition).

A laundry detergent according to the invention is preferably in liquid form.

A liquid laundry detergent according to the invention may generally comprise from 5 to 95%, preferably from 10 to 90%, more preferably from 15 to 85% water (by weight based on the total weight of the composition). The composition may also incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included in a liquid laundry detergent according to the invention, may be present in an amount ranging from 0.1 to 20%, preferably from 1 to 15%, and more preferably from 3 to 12% (by weight based on the total weight of the composition).

### Builders

A laundry detergent according to the invention may contain one or more builders. Builders enhance or maintain the cleaning efficiency of the surfactant, primarily by reducing water hardness. This is done either by sequestration or chelation (holding hardness minerals in solution), by precipitation (forming an insoluble substance), or by ion exchange (trading electrically charged particles).

Builders for use in the invention can be of the organic or inorganic type, or a mixture thereof. Non-phosphate builders are preferred.

Inorganic, non-phosphate builders for use in the invention include hydroxides, carbonates, silicates, zeolites, and mixtures thereof.

Suitable hydroxide builders for use in the invention include sodium and potassium hydroxide.

Suitable carbonate builders for use in the invention include mixed or separate, anhydrous or partially hydrated alkali metal carbonates, bicarbonates or sesquicarbonates.

Preferably the alkali metal is sodium and/or potassium, with sodium carbonate being particularly preferred.

Suitable silicate builders include amorphous forms and/or crystalline forms of alkali metal (such as sodium) silicates. Preferred are crystalline layered sodium silicates (phyllosilicates) of the general formula (I)

NaMSiₓO₂ₓ₊₁·yH₂O (I)

in which M is sodium or hydrogen, x is a number from 1.9 to 4, preferably 2 or 3 and y is a number from 0 to 20. Sodium disilicates of the above formula in which M is sodium and x is 2 are particularly preferred. Such materials can be prepared with different crystal structures, referred to as α, β, γ and δ phases, with δ-sodium disilicate being most preferred.

Zeolites are naturally occurring or synthetic crystalline aluminosilicates composed of (SiO₄)⁴⁻ and (AlO₄)⁵⁻ tetrahedra, which share oxygen-bridging vertices and form cage-like structures in crystalline form. The ratio between oxygen, aluminium and silicon is O:(Al+Si)=2:1. The frameworks acquire their negative charge by substitution of some Si by Al. The negative charge is neutralised by cations and the frameworks are sufficiently open to contain, under normal conditions, mobile water molecules. Suitable zeolite builders for use in the invention may be defined by the general formula (II):

Naₓ[(AlO₂)ₓ(SiO₂)_{y}]·zH₂O (II)

in which x and y are integers of at least 6, the molar ratio of x to y is in the range from about 1 to about 0.5, and z is an integer of at least 5, preferably from about 7.5 to about 276, more preferably from about 10 to about 264.

Preferred inorganic, non-phosphate builders for use in the invention may be selected from zeolites (of the general formula (II) defined above), sodium carbonate, δ-sodium disilicate and mixtures thereof.

Suitable organic, non-phosphate builders for use in the invention include polycarboxylates, in acid and/or salt form. When utilized in salt form, alkali metal (e.g. sodium and potassium) or alkanolammonium salts are preferred. Specific examples of such materials include sodium and potassium citrates, sodium and potassium tartrates, the sodium and potassium salts of tartaric acid monosuccinate, the sodium and potassium salts of tartaric acid disuccinate, sodium and potassium ethylenediaminetetraacetates, sodium and potassium N(2-hydroxyethyl)-ethylenediamine triacetates, sodium and potassium nitrilotriacetates and sodium and potassium N-(2-hydroxyethyl)-nitrilodiacetates. Polymeric polycarboxylates may also be used, such as polymers of unsaturated monocarboxylic acids (e.g. acrylic, methacrylic, vinylacetic, and crotonic acids) and/or unsaturated dicarboxylic acids (e.g. maleic, fumaric, itaconic, mesaconic and citraconic acids and their anhydrides). Specific examples of such materials include polyacrylic acid, polymaleic acid, and copolymers of acrylic and maleic acid. The polymers may be in acid, salt or partially neutralised form and may suitably have a molecular weight (Mw) ranging from about 1,000 to 100,000, preferably from about 2,000 to about 85,000, and more preferably from about 2,500 to about 75,000.

Preferred organic, non-phosphate builders for builders for use in the invention may be selected from polycarboxylates (e.g. citrates) in acid and/or salt form and mixtures thereof.

Mixtures of any of the above described materials may also be used.

Preferably the level of phosphate builders in a laundry detergent of the invention is no more than 1%, more preferably no more than 0.1% and most preferably 0% (by weight based on the total weight of the composition). The term “phosphate builder” in the context of this invention denotes alkali metal, ammonium and alkanolammonium salts of polyphosphate, orthophosphate, and/or metaphosphate (e.g. sodium tripolyphosphate).

The overall level of builder, when included, may range from about 0.1 to about 80%, preferably from about 0.5 to about 50% (by weight based on the total weight of the composition).

### Polymeric Cleaning Boosters

A laundry detergent according to the invention may also include one or more polymeric cleaning boosters such as antiredeposition polymers, soil release polymers and mixtures thereof.

Anti-redeposition polymers stabilise the soil in the wash solution thus preventing redeposition of the soil. Suitable anti-redeposition polymers for use in the invention include alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethylenimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone. Another type of suitable anti-redeposition polymer for use in the invention includes cellulose esters and ethers, for example sodium carboxymethyl cellulose.

Mixtures of any of the above described materials may also be used.

The overall level of anti-redeposition polymer, when included, may range from 0.05 to 6%, more preferably from 0.1 to 5% (by weight based on the total weight of the composition).

Soil release polymers help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

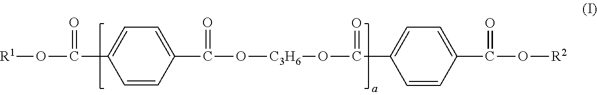

in which R¹ and R² independently of one another are X—(OC₂H₄)ₙ—(OC₃H₆)ₘ;
in which X is C₁-4 alkyl and preferably methyl;
n is a number from 12 to 120, preferably from 40 to 50;
m is a number from 1 to 10, preferably from 1 to 7; and
a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, preferably from 0.3 to 7%, more preferably from 0.5 to 5% (by weight based on the total weight of the composition).

### Transition Metal Ion Chelating Agents

A liquid or particulate laundry detergent according to the invention may contain one or more chelating agents for transition metal ions such as iron, copper and manganese. Such chelating agents may help to improve the stability of the composition and protect for example against transition metal catalysed decomposition of certain ingredients.

Suitable transition metal ion chelating agents include phosphonates, in acid and/or salt form. When utilized in salt form, alkali metal (e.g. sodium and potassium) or alkanolammonium salts are preferred. Specific examples of such materials include aminotris(methylene phosphonic acid) (ATMP), 1-hydroxyethylidene diphosphonic acid (HEDP) and diethylenetriamine penta(methylene phosphonic acid (DTPMP) and their respective sodium or potassium salts. HEDP is preferred. Mixtures of any of the above described materials may also be used.

Transition metal ion chelating agents, when included, may be present in an amount ranging from about 0.1 to about 10%, preferably from about 0.1 to about 3% (by weight based on the total weight of the composition).

### Fatty Acid

A laundry detergent according to the invention may in some cases contain one or more fatty acids and/or salts thereof.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

Fatty acids and/or their salts, when included, may be present in an amount ranging from about 0.25 to 5%, more preferably from 0.5 to 5%, most preferably from 0.75 to 4% (by weight based on the total weight of the composition).

For formula accounting purposes, in the formulation, fatty acids and/or their salts (as defined above) are not included in the level of surfactant or in the level of builder.

### Rheology Modifiers

A liquid laundry detergent according to the invention may comprise one or more rheology modifiers. Examples of such materials include polymeric thickeners and/or structurants such as hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂-C₂₂ alkyl) polyethoxylated (meth)acrylates; and (ii) at least one further monomer selected from C₁-C₄ alkyl (meth) acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

Polymeric thickeners, when included, may be present in an amount ranging from 0.1 to 5% (by weight based on the total weight of the composition).

A liquid laundry detergent according to the invention may also have its rheology modified by use of one or more external structurants which form a structuring network within the composition. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

### Enzymes

A laundry detergent according to the invention may comprise an effective amount of one or more enzymes selected from the group comprising, pectate lyase, protease, amylase, cellulase, lipase, mannanase and mixtures thereof. The enzymes are preferably present with corresponding enzyme stabilizers.

A liquid laundry detergent according to the invention preferably has a pH in the range of 5 to 9, more preferably 6 to 8, when measured on dilution of the composition to 1% (by weight based on the total weight of the composition) using demineralised water.

### Fragrances

Examples of fragrant components include aromatic, aliphatic and araliphatic hydrocarbons having molecular weights from about 90 to about 250; aromatic, aliphatic and araliphatic esters having molecular weights from about 130 to about 250; aromatic, aliphatic and araliphatic nitriles having molecular weights from about 90 to about 250; aromatic, aliphatic and araliphatic alcohols having molecular weights from about 90 to about 240; aromatic, aliphatic and araliphatic ketones having molecular weights from about 150 to about 270; aromatic, aliphatic and araliphatic lactones having molecular weights from about 130 to about 290; aromatic, aliphatic and araliphatic aldehydes having molecular weights from about 90 to about 230; aromatic, aliphatic and araliphatic ethers having molecular weights from about 150 to about 270; and condensation products of aldehydes and amines having molecular weights from about 180 to about 320.

### Further Optional Ingredients

A laundry treatment composition of the invention may contain further optional ingredients to enhance performance and/or consumer acceptability. Examples of such ingredients including fragrances either as free oil or encapsulated (in addition to the encapsulates of the invention). foam boosting agents, preservatives (e.g. bactericides), antioxidants, sunscreens, anticorrosion agents, colorants, pearlisers and/or opacifiers, and shading dye. Each of these ingredients will be present in an amount effective to accomplish its purpose. Generally, these optional ingredients are included individually at an amount of up to 5% (by weight based on the total weight of the composition).

### Packaging and Dosing

A laundry treatment composition of the invention may be packaged as unit doses in polymeric film soluble in the wash water. Alternatively, a composition of the invention may be supplied in multidose plastics packs with a top or bottom closure. A dosing measure may be supplied with the pack either as a part of the cap or as an integrated system.

A method of treating fabric using a laundry detergent according to the invention will usually involve diluting the dose of detergent to obtain a treatment liquor e.g. a wash liquor, and treating fabrics with the liquor so formed. The method may be carried out in an automatic washing machine, or can be carried out by hand. The method may include the step of immersing the fabrics in the liquor, or applying the liquor or the (undiluted) composition to the fabrics.

In automatic washing machines, the dose of detergent is typically put into a dispenser and from there it is flushed into the machine by the water flowing into the machine, thereby forming the wash liquor. Alternatively, the dose of detergent may be added directly into the drum. Dosages for a typical front-loading washing machine (using 10 to 15 litres of water to form the wash liquor) may range from about 10 ml to about 60 ml, preferably about 15 to 40 ml. Dosages for a typical top-loading washing machine (using from 40 to 60 litres of water to form the wash liquor) may be higher, e.g. up to about 100 ml. Lower dosages of detergent (e.g. 50 ml or less) may be used for hand washing methods (using about 1 to 10 litres of water to form the wash liquor). A subsequent aqueous rinse step and drying the laundry is preferred. Any input of water during any optional rinsing step(s) is not included when determining the volume of the wash liquor.

The laundry drying step can take place either in an automatic dryer or in the open air.

The invention will now be further described with reference to the following non-limiting Examples.

### EXAMPLES

All weight percentages are by weight based on total weight unless otherwise specified.

### Example 1—Synthesis of Polylactic Acid Shell and Ester Oil Core Benign Encapsulates Using Recycled Polyester

The materials used in the encapsulation are given in the following table:

| Material | Supplier | % Active |
|---|---|---|
| Dichloromethane | Aldrich | 100% |
| Waste Polylactic Acid (PLA) | (Vegware) | 100% |
| waste drinking cup) | | |
| Benefit agent: castor oil | Aldrich | 100% |
| Hostasol Yellow 3G | Clariant | 100% |
| Polyvinyl Alcohol (Mowiol 4-88) | Aldrich | 100% |
| Xyloglucan (Glyloid 3S) | DSP Gokyo Food and | 100% |
| | Chemical Company | |

### Step 1) Synthesis of Polyester Encapsulates

A 1 wt % xyloglucan aqueous stock solution was prepared by dissolving 1 g of xyloglucan (Glyloid 3S) into 99 g of boiled water by homogenising for 5 minutes at 8,000 rpm.

A 4 wt % polyvinyl alcohol stock solution was made by adding 20 g Mowiol 4-88 slowly into boiled water with vigorous overhead stirring.

An oil phase was prepared by cutting a waste polylactic acid water cup into small pieces (˜1×1 cm). 5.1 g of these pieces, 11.9 g of castor oil and 0.0024 g of Hostasol Yellow 3G were dissolved in 50 ml of dichloromethane, by agitating overnight to achieve dissolution.

An aqueous phase was prepared by mixing 61.0 g of the 4 wt % polyvinyl alcohol stock with 34.0 g of the 1 wt % xyloglucan stock solution.

The oil and aqueous phases were mixed and homogenised for 2 minutes at 12,000 rpm to generate an O/W emulsion. This was transferred to a rotary evaporator flask and the organic solvent (dichloromethane) removed by rotary evaporation, at room temperature, by gradual reduction of the pressure to 200 mbar over approximately 2 hours.

### Step 2) Grafting of Xyloglucan

To this encapsulate, coupling agent (4 wt % on encapsulate weight) was added to facilitate xyloglucan grafting, using the following method:

A fresh aqueous solution of coupling agent was prepared by dissolving 0.5 g of 1-ethyl-3-(3′-dimethylaminopropyl)carbodiimide (EDAC), HCl salt (Aldrich) in 4.5 g deionised water. This solution was used within 15 minutes.

20 ml of the recycled polyester encapsulate was added to a small vial and 1.7 ml of the fresh EDAC solution was added (4 wt % EDAC on encapsulate weight). These mixtures were agitated overnight to facilitate chemical grafting of the xyloglucan to the encapsulates.

A final encapsulate dispersion (21.7 g), consisting of 19.6 wt % encapsulate solids (11.5% castor oil solids) on total weight, was obtained thus recycling the PLA of the waste cup. This was composed of a recycled polylactic acid shell and castor oil core (30/70 respectively), containing 2 wt % (on final encapsulate weight) of grafted xyloglucan. The particle size was approximately 3 microns.

Encapsulate solids were determined at 50° C., to constant weight, with Ohaus moisture balance. Particle size (d(0.5)) was determined using a Mastersizer 3000 from Malvern Panalytical.

1. A benefit agent delivery particle for use in the treatment of fabrics, the particle comprising a core-shell structure in which a shell of polymeric material entraps a core containing benefit agent, wherein the average particle size is 100 nanometers and 50 microns and said shell comprises a waste polymer comprising post-consumer recycled (PCR) polymer(s) or post-industrial recycled (PIR) polymer(s) and mixtures thereof.

2. The benefit agent delivery particle according to claim 1, wherein the waste polymer comprises waste polyester.

3. The benefit agent delivery particle according to claim 1, wherein the recycled polymer comprises waste aliphatic polyester.

4. The benefit agent delivery particle according to claim 1, wherein the recycled polymer comprises waste polylactic acid.

5. The benefit agent delivery particle according to claim 1, wherein the particle further comprises a deposition aid.

6. The benefit agent delivery particle according to claim 5, wherein the deposition aid comprises a polysaccharide, preferably a nonionic polysaccharide.

7. The benefit agent delivery particle according to claim 6, wherein the deposition aid comprises a polysaccharide with a 1-4 linked β glycan backbone structure with at least 4, and preferably at least 10 backbone residues which are β1-4 linked.

8. The benefit agent delivery particle according to claim 6, wherein the deposition aid comprises xyloglucan or a galactomannan.

9. The benefit agent delivery particle according to claim 7, wherein the deposition aid comprises polysaccharides such as cellulose mono-acetate; or modified polysaccharides with an affinity for cellulose such as hydroxypropyl cellulose (HPC), hydroxypropyl methylcellulose, hydroxyethyl methylcellulose, hydroxypropyl guar, hydroxyethyl ethylcellulose and methylcellulose.

10. A laundry treatment composition comprising the benefit agent delivery particle according to claim 1.

11. A method of treating laundry comprising the step of diluting a dose of the laundry treatment composition of claim 10 to obtain a treatment liquor, and treating fabrics with the treatment liquor so formed.

12. A method of making a benefit agent delivery particle for use in the treatment of fabrics, the particle comprising a core-shell structure in which a shell entraps a core containing benefit agent and the particle has an average particle size between 100 nanometers and 50 microns, the method comprising the steps of:
a) providing a waste polymer feedstock comprising post-consumer recycled (PCR) polymer(s) or post-industrial recycled (PIR) polymer(s) and mixtures thereof; and
b) forming the shell from the waste polymer feedstock to entrap the benefit agent.

13. The method according to claim 12, wherein the waste polymer feedstock is derived from waste polymeric packaging.

14. The method according to claim 12, wherein step (b) includes solvation of the waste polymer feedstock with a solvent.

15. (canceled)
